(19) United States
(12) Patent Application Publication
(10) Pub. No.: US 2018/0195475 A1
(43) Pub. Date: Jul. 12, 2018

(54) FILTER ASSEMBLY

(71) Applicant: CHAMPION LABORATORIES, INC., Albion, IL (US)

(72) Inventor: Zafar Hussain, Albion, IL (US)

(21) Appl. No.: 15/847,570

(22) Filed: Dec. 19, 2017

Related U.S. Application Data
(60) Provisional application No. 62/436,406, filed on Dec. 19, 2016.

(51) Int. Cl. F02M 37/22; B01D 63/06; B01D 69/04; B01D 63/14

(52) U.S. Cl. CPC F02M 37/221; B01D 63/067; B01D 63/065; B01D 69/04; B01D 63/14; B01D 2325/38; B01D 2257/80; B01D 2313/08; B01D 2313/125; B01D 2313/20; B01D 2201/32

(57) ABSTRACT

A filter assembly that includes a water separator as part of the filter assembly. The water separator is arranged in the filter assembly and includes a filter element that is provided with a hydrophobic medium through which fuel/lubricant can pass through. The filter assembly also includes a water separator positioned downstream from the filter element. During the operation of the filter assembly, the water separator causes the water in the fuel to be separated and accumulate on the hydrophobic surface of the water separator and, due to the gravity, allows the water to flow downwards along the surface of the water separator into a water collection/sedimentation chamber where it can be evacuated from the filter through one or more passageways.

### CROSS-REFERENCE TO RELATED APPLICATION

The present invention claims priority to U.S. Provisional Application No. 62/436,406, filed Dec. 19, 2016, the entirety of which is incorporated by reference herein.

### FIELD OF THE DISCLOSURE

The present disclosure relates generally to filter devices for an interval combustion engine of a motor vehicle.

### BACKGROUND

The present disclosure relates generally to filters and more particularly to fuel filters that are used to remove water and contaminants from fuel before being used by an internal combustion engine.

Filters, in particular fuel filters, are commonly used in modern motor vehicles and serve for cleaning the fuel. Typically commercially available fuel, such as diesel fuel, contains an insignificant amount of water, which affects the fuel with respect to its function and increases the corrosion risk for the internal combustion engine, which can cause engine damage and functionality issues. To remove water from the fuel, water separators are typically used. Water separators are designed to filter out or separate the water content still contained in the fuel. The more water separation that occurs, the lower the corrosion risk and the lower the risk of an adverse effect on the function of the internal combustion engine caused by the water.

### SUMMARY

The present disclosure may comprise one or more of the following features and combinations thereof.

In illustrative embodiments, the present disclosure includes a water separator in a filter assembly, in particular a fuel or lubricant filter. The water separator is arranged in the filter assembly which comprises a filter element that includes a hydrophobic medium through which fuel/lubricant can flow from a radially outward to a radially inward direction. The filter assembly also includes a water separator positioned downstream from the filter element. The water separator is in the form of an annular element. The water separator is arranged vertically and the flow of fuel passes therethrough from a radially outward to a radially inward location. During the operation of the filter assembly according to the present disclosure, the water separator causes the water in the fuel to be separated and accumulate on the hydrophobic surface of the water separator and, due to the gravity, allows the water to flow downwards along the surface of the water separator into a water collection/sedimentation chamber. The low flow velocity within the chamber of the water separator permits a particularly high sedimentation rate for water to be separated. In use, fuel flow passes through the filter element of the filter assembly from a radially outward direction to a radially inward direction, wherein in the axial direction between the filter element and the water separator, a flow passageway is provided which connects the pure end of the filter element with the raw end of the water separator and through which the filtered fuel flows. Fuel through the flow passageway encounters the raw end of the water separator, where water is separated from the fuel.

These and other features of the present disclosure will become more apparent from the following description of the illustrative embodiments.

### BRIEF DESCRIPTION OF THE DRAWINGS

FIG. 1 is a perspective view of the filter assembly showing a filter element, an upper end cap and a lower housing;

FIG. 2 is partial sectional view of FIG. 1 showing the filter element and the water separator filter in the lower portion of the filter assembly;

FIG. 3 is a top view of the upper end cap of the filter assembly;

FIG. 4 is a bottom view of the housing of the filter assembly showing a central opening adapted for the passage of fuel with water removed and an offset water drain outlet;

FIG. 5 is an exploded view of the filter assembly;

FIG. 6 is a perspective view of a vent cap;

FIG. 7 is a perspective view of a perforated inner filter support tube;

FIG. 8 is a perspective top view of an upper end cap of the filter assembly;

FIG. 9 is a perspective view of an upper housing member;

FIG. 10 is a perspective view of the central tube member and base plate having flow directors;

FIG. 11 is a perspective view of a perforated core support for the water separator;

FIG. 12 is a perspective view of the water separator;

FIG. 13 is a perspective view of the lower housing member;

FIG. 14 is a sectional view taken along line 14-14 of FIG. 1; and

FIG. 15 is a sectional view similar to FIG. 14 but includes the central tube of the filter housing that the filter assembly fits over.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

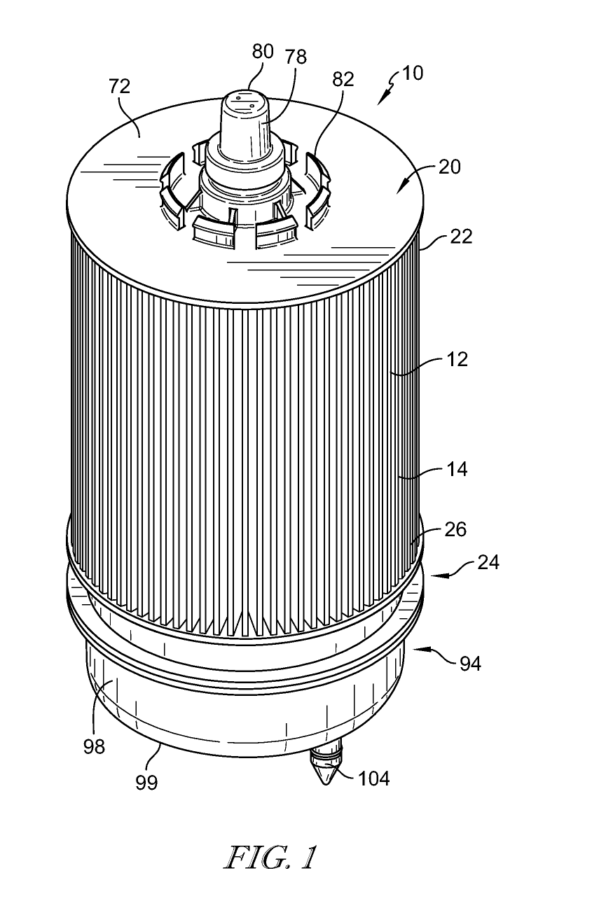

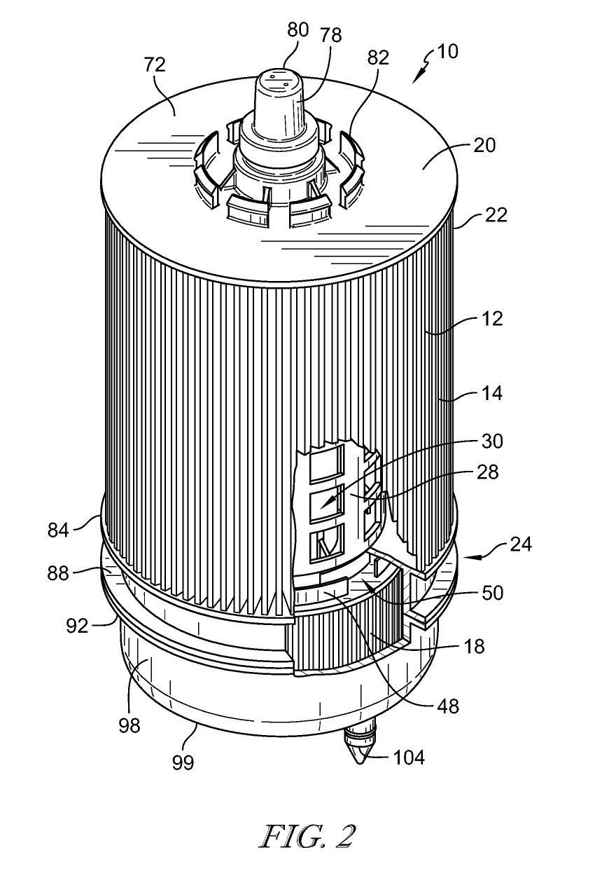

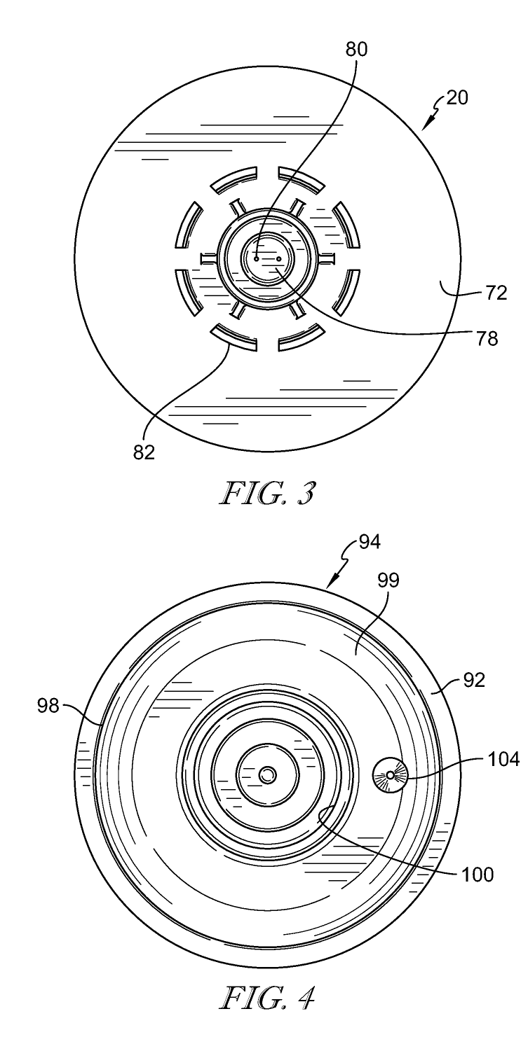

This disclosure describes a fuel filter assembly 10 that is adapted to filter out sediment and water from a fuel supply, as shown in FIG. 1. The filter assembly 10 includes an annular filter element 12 through which a flow of fuel penetrates in a radial direction from a dirty side 14 to a clean side 16. As shown in the figures, the dirty side 14 is located radially on the outside while the clean side 16 of the filter element 12 is arranged radially on the inside. Below the filter element 12 a water separator 18 is positioned, which is also penetrated by the flow of fuel from a radially outward direction to a radially inward direction after the fuel has passed through the filter element 12 as shown in FIG. 2. Filter element 12 is preferably a coalescing type pleated paper media that includes fiberglass strands used to coalesce the water in the fuel into droplets on the clean side 16 of the filter element 12. The water, being heavier than the fuel, runs down the inside of the filter element 12 to the flow passage 50.

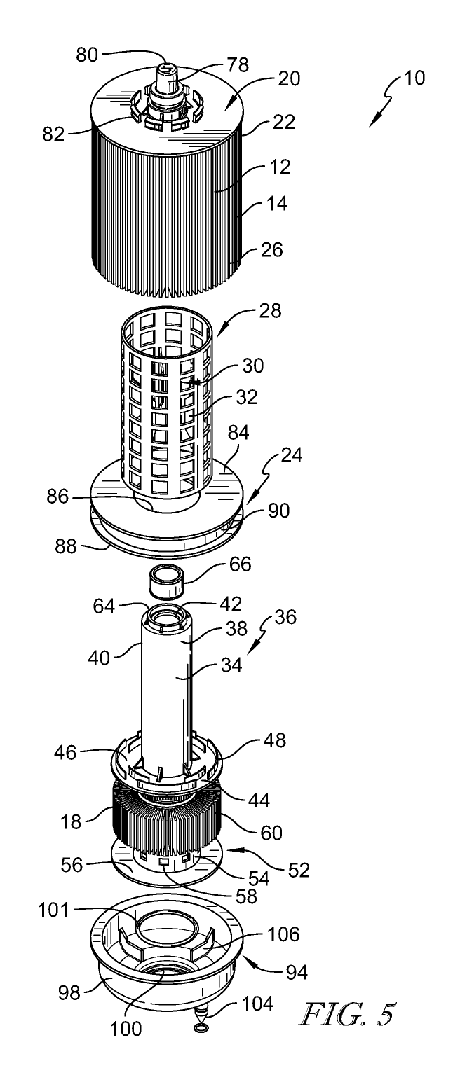

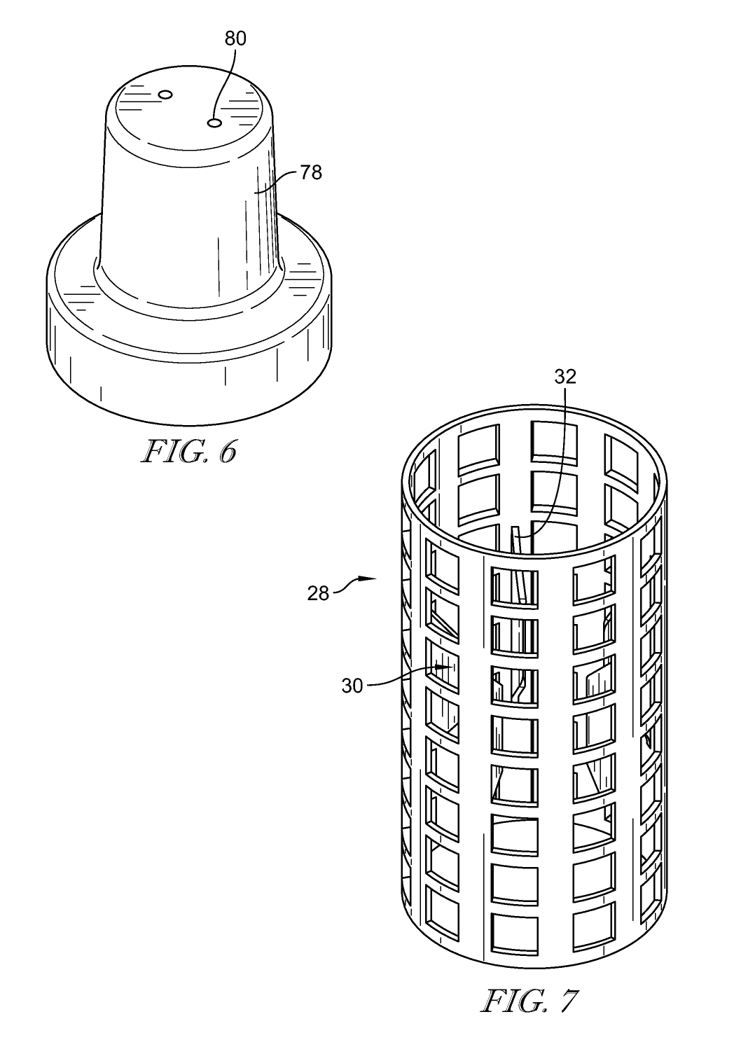

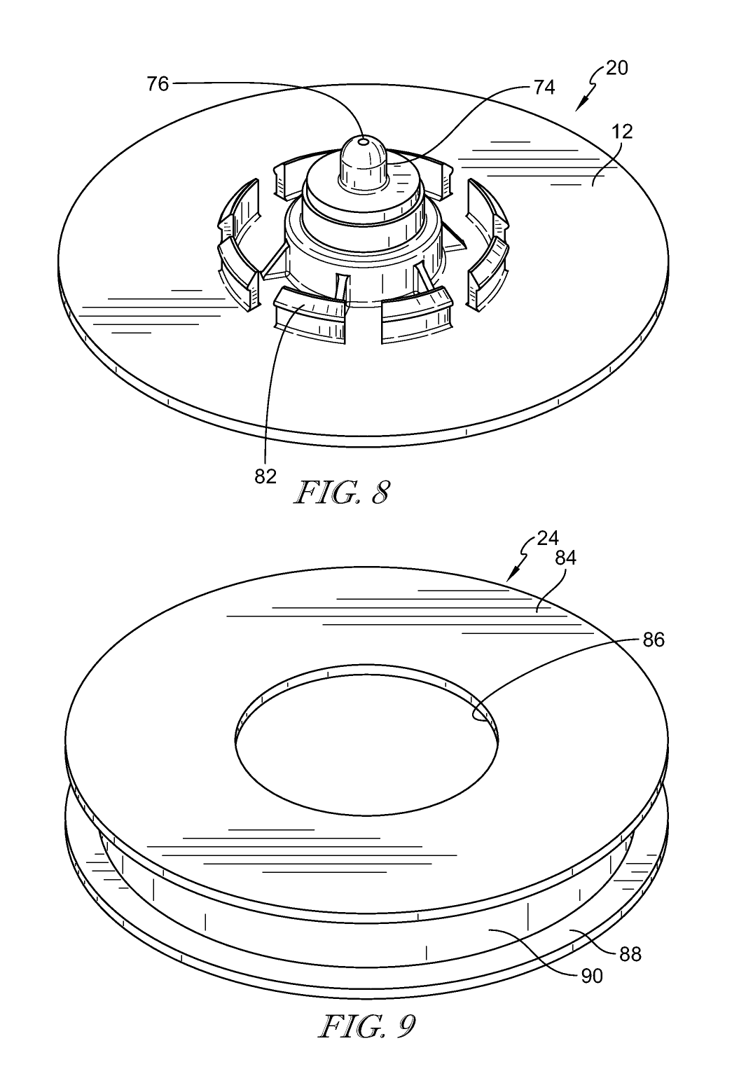

The fuel filter assembly 10 includes an end cap 20 located at a first end 22 of the filter element 12 and an upper housing 24 located at a second end 26 of the filter 12 as shown in FIG. 1. The filter assembly 10 also includes a core support tube 28 positioned radially inward from the filter element 12 as shown in FIG. 2. Core support tube 28 includes a plurality of apertures 30 that permit the passage of fuel. Core support tube 28 prevents the unwanted collapse of the filter element 12 during use. Core support tube 28 extends from the first end 22 to the second end 26 of the filter element 12 and includes a series of radially inwardly extending ribs 32 that engage center tube 34 for support as shown in FIGS. 5 and 7.

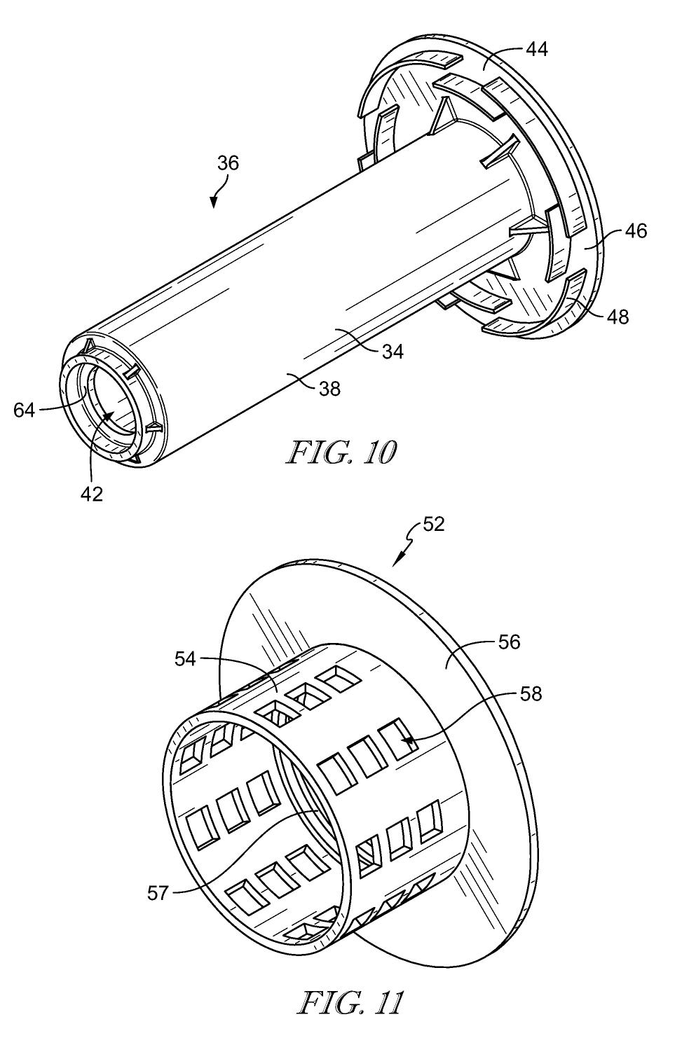

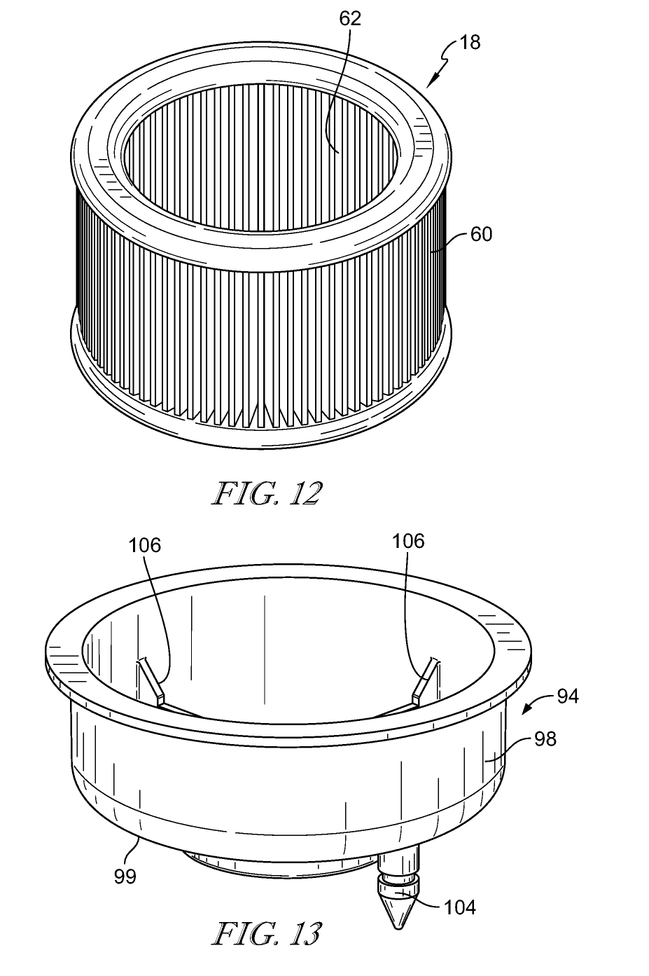

Element assembly 36 is positioned within filter assembly 10 and includes center tube 34 that includes an annular wall 38 and a top end 40 as shown in FIGS. 5 and 10. Top end 40 is formed to include an opening 42 to permit the flow of fuel that has been scrubbed of particulate matter and water. Center tube 34 of element assembly 36 includes an annular flange 44 that extends radially outwardly from the center tube 34 and includes a central opening. Annular flange 44 includes a top surface 46 that includes a series of axially extending arced wall segments 48. Arced wall segments 48 overlap with one another to slow the flowrate of fuel traveling radially outward through flow passage 50 of filter assembly 10. Annular flange 44 is adapted to be coupled to water separator 18 by use of an adhesive or by heat bonding.

Element assembly 36 also includes second core support 52 that includes vertical tube 54 and bottom flange 56 as shown in FIGS. 4 and 5. Vertical tube 54 is formed to include a series of openings 58 to permit the passage of fuel that has passed from the dirty side 60 to the clean side 62 of water separator 18. Water separator 18 is a pleated media that is provided with a coating that prevents water from passing through the media. Water droplets eventually form on the outside of the water separator 18 where they collect and are drained away by gravity.

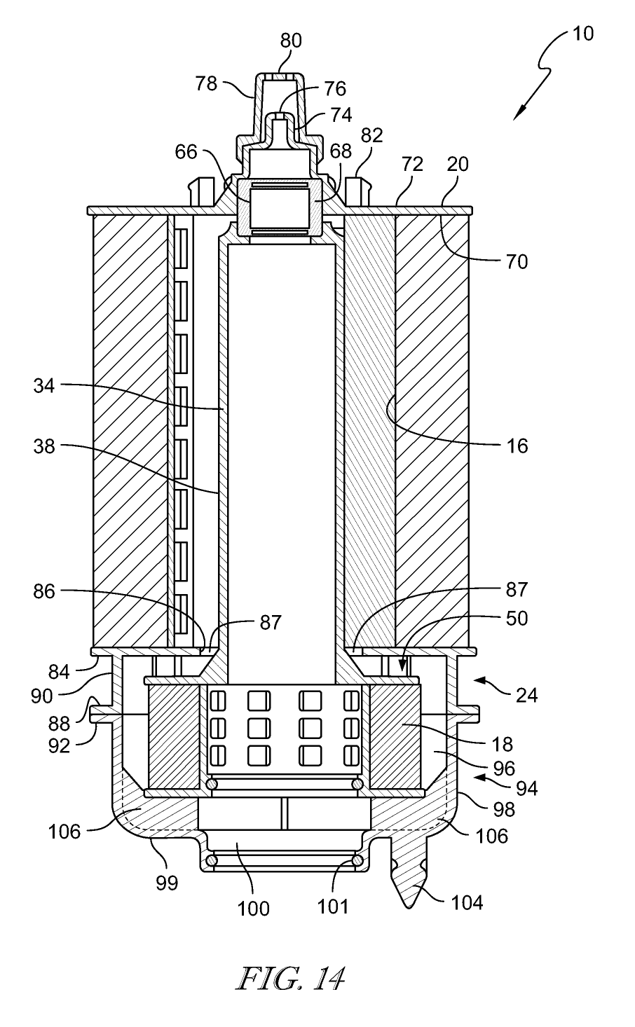

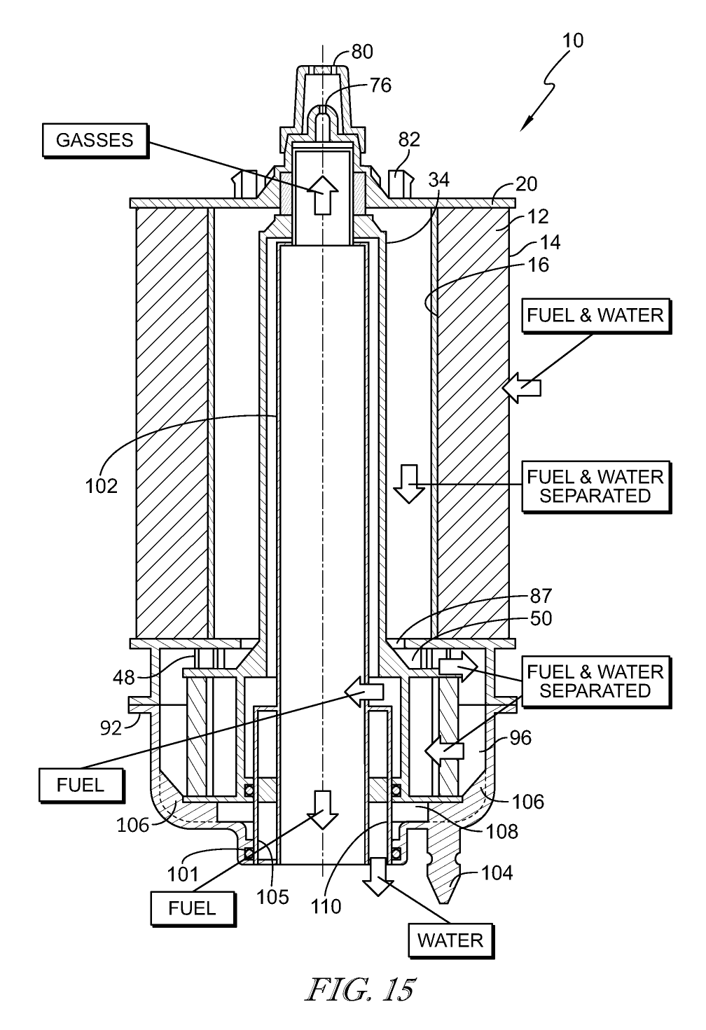

Bottom flange 56 of core support 52 and annular flange 44 are coupled to the pleated water separator 18 and are attached with adhesive or heat bonding the plastic. The water separator media is a water stripping media and is a fiber media with a silicon coating that prevents water from passing through the media. The top end 40 of center tube 34 is formed to include a recess 64 as shown in FIGS. 5 and 10. The recess 64 is adapted to accept a cylindrical seal 66. Seal 66 seals center tube 34 against end cap 20 as shown in FIG. 14. Bottom flange 56 includes a central opening 57 that is adapted to permit the passage of fuel that is void of water, as shown in FIG. 15. Central opening 57 is fitted with a seal, such as an o-ring to seal flange 56 against a center tube 102 of filter housing (not shown).

End cap 20 is located at the top of filter assembly 10 and includes a bottom side 70 and a top side 72 as shown in FIGS. 1 and 2. End cap 20 includes a recess 68 formed in the bottom side 70 that is adapted to accept a portion of seal 66 as shown in FIG. 14. Top side 72 of end cap 20 includes a central vent pintle 74 that includes a central vent aperture 76 that is adapted to vent any gases from inside the filter assembly 10. End cap 20 is fitted with a vent cap 78 that is adapted to fit over vent pintle 74 to direct vented gas from vent aperture 76 out through vent openings 80. Top side 72 of end cap 20 also includes a plurality of annular flanges 82 that are adapted to permit the filter to be removably coupled to a filter housing cap.

Upper housing 24 of filter assembly 10 is positioned below filter element 12 as shown in FIGS. 5 and 9. Upper housing 24 includes an upper flange 84 that is adapted to be coupled to the filter element 12 by use of an adhesive or other bonding method. Upper flange 84 includes a central opening 86 that has a diameter larger than the annular wall 38 of the center tube 34 as shown in FIGS. 14 and 15. This forms a space or passageway 87 for fuel and water that has passed through the filter element 12 to enter the flow passage 50. Upper housing 24 also includes a lower flange 88 that is spaced from upper flange 84 by an annular side wall 90. Lower flange 88 is adapted to be coupled to an upper flange 92 of lower housing 94. The two housing are coupled together by heat welding or use of an adhesive.

Lower housing 94 cooperates with upper housing 24 to form a lower chamber 96 for water separator 18 as shown in FIGS. 5 and 13. Lower housing 94 includes an annular side wall 98 and a bottom wall 99. Bottom wall 99 is formed with a central opening 100. As shown in FIGS. 14 and 15, central opening 100 is formed to include a seal 101, such as an o-ring, to seal the lower housing 94 against an outer central tube 102 of the housing (not shown). Bottom wall 99 also includes a locating pin 104. Locating pin 104 is adapted to assist a user in inserting the filter assembly 10 within the filter housing of the vehicle (not shown). Bottom wall 99 includes a series of ribs 106 that are adapted support bottom flange 56 of second core support 52. This arrangement creates flow passages 108 for water to exit through apertures 110 formed in outer central tube 105 of the housing.

In use and as best illustrated in FIG. 15, a blend of fuel and water mixture external to the filter element 12 pass through filter element 12 from the dirty side 14 to the clean side 16. The coalescing media of filter element 12 causes water to coalesce and separate out from the fuel along the clean side 16 of the filter element 12. Separated fuel and water both travel axially downwardly through filter assembly along the outside of center tube 34 through passageway 87 and into flow passage 50. Flow passage 50 includes the series of arced segments 48 that slow the fuel and water flow as it enters the lower chamber 96. Water, which is heavier than fuel settles in lower chamber 96 and moves through flow passages 108 and out apertures 110 of central tube 102. Fuel passes through water separator 18 and into center tube 102 and toward the motor. Air and other gasses are permitted to exit the filter assembly 10 through vent apertures 76 and vent openings 80.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A filter assembly for filtering out sediment and water from a fuel supply comprising:
an annular filter element through which a flow of fuel can penetrate in a radial direction;
a first end cap located at a first end of the filter element and an upper housing located at a second end of the filter element;
a first core support tube located radially inward from the filter element;
an element assembly having a center tube, a tube flange located at one end of the center tube and a second core support tube having a core flange at one end;
a water separator positioned between the tube flange and the core flange the water separate adapted to separate water from the fuel;
a lower housing adapted to be coupled to the upper housing, the upper and lower housings adapted to contain the water separator.

2. The filter assembly of claim 1, wherein the tube flange includes a series of arced wall segments adapted to slow the flow of fuel exiting the filter element and traveling to the water separator.

3. The filter assembly of claim 1, wherein the second core support is positioned radially inward from the water separator.

4. The filter assembly of claim 3, wherein the lower housing includes at least one rib that assists in directing the flow of water separated from the fuel.

5. The filter assembly of claim 4, wherein the core flange is supported by the at least one rib.

6. The filter assembly of claim 5, wherein spacing of the core flange from a lower wall of the lower housing creates a flow passage for water.

7. The filter assembly of claim 1, wherein the core support tube includes a plurality of apertures adapted to permit the flow of fuel from the filter element.

8. The filter assembly of claim 8, wherein the center tube of the element assembly is positioned radially inward from the core support tube.

9. The filter assembly of claim 1, wherein the filter element is made from a pleated media.

10. The filter assembly of claim 9, wherein the water separator is made from a pleated media.

11. A filter assembly for filter out water from a fuel supply comprising:
an annular filter element adapted to at least partially separate out water from a fuel supply;
a first end cap positioned at a first end of the filter element;
a second end cap positioned at a second end of the filter element, the second end cap forming part of a housing;
an element assembly including a center tube a first flange positioned at one end of the center tube, a second flange spaced from the first flange and a water separator positioned between the first and second flanges;
a lower housing portion adapted to engage the second end cap to form a water separator housing for housing the water separator;
wherein the water separator separates water from the fuel supply and collects the water in the housing.

12. The filter assembly of claim 11, wherein the center tube includes an aperture at an upper end.

13. The filter assembly of claim 11, wherein the second end cap is formed to include an aperture that permits fuel and water to pass between the center tube and the second end cap into the housing.

14. The filter assembly of claim 13, wherein the first flange includes a series of overlapping arced segments to slow the flowrate of water and fuel existing the aperture of the second end cap.

15. The filter assembly of claim 11, wherein the first end cap includes an aperture adapted to permit the passage of gas.

16. The filter assembly of claim 11, wherein the filter element is made from a pleated media.

17. The filter assembly of claim 16, wherein the water separator is made from a pleated media.

18. The filter assembly of claim 11, wherein the lower housing includes at least one rib that assists in directing the flow of water separated from the fuel.

19. The filter assembly of claim 18, wherein the second flange is supported by the at least one rib.

20. The filter assembly of claim 19, wherein spacing of the second flange from a lower wall of the lower housing creates a flow passage for water to permit draining of the water.
